(19) United States
(12) Patent Application Publication
(10) Pub. No.: US 2023/0367310 A1
(43) Pub. Date: Nov. 16, 2023

(54) TELEPRESENCE SYSTEM FOR A MOTOR VEHICLE

(71) Applicant: GM GLOBAL TECHNOLOGY OPERATIONS LLC, Detroit, MI (US)

(72) Inventor: Brian V. Castillo, Birmingham, MI (US)

(73) Assignee: GM GLOBAL TECHNOLOGY OPERATIONS LLC, Detroit, MI (US)

(21) Appl. No.: 17/742,575

(22) Filed: May 12, 2022

(51) Int. Cl. G05D 1/00; B60R 1/25; B60R 11/04; G06T 3/40; H04W 4/40

(52) U.S. Cl. CPC G05D 1/0038; G05D 1/005; G05D 1/0022; B60R 1/25; B60R 11/04; G06T 3/4038; H04W 4/40; G05D 2201/0213; B60R 2300/105; B60R 2300/303; B60R 2300/406

(57) ABSTRACT

A telepresence system for a motor vehicle includes a first telecommunication device arranged on the vehicle for receiving audio and video data from a remote source via a second telecommunication device. The system also includes an audio speaker arranged on the vehicle exterior for reproducing the received audio data and a visual display device facing the vehicle exterior for displaying the video data toward an environment surrounding the vehicle. The system additionally includes a microphone for capturing sound proximate the vehicle and communicating the captured sound to the first telecommunication device. The system further includes a camera for generating an image of the surrounding environment and communicating the generated image to the first telecommunication device. The first telecommunication device is additionally configured to communicate the captured sound and the generated image to the second telecommunication device to thereby establish real-time communication between the surrounding environment and the remote source.

### INTRODUCTION

The present disclosure is drawn to a system providing virtual- or tele-presence of a person inside a motor vehicle.

Although traditionally motor vehicles are operated by a driver situated inside the subject vehicle, recent developments have established ability of motor vehicles to operate semi and fully autonomously. Such “autonomous vehicles” typically employ sensors operable to sense the environment surrounding the vehicle together with a computing device operable to control various aspects of vehicle operation.

Autonomy in vehicles is often categorized in discrete levels, such as Level 1—Driver assistance—where the vehicle may control either steering or speed autonomously in specific circumstances to assist the driver; Level 2—Partial automation—where the vehicle may control both steering and speed autonomously in specific circumstances to assist the driver; Level 3—Conditional automation—where the vehicle may control both steering and speed autonomously under normal environmental conditions, but requires driver oversight; Level 4—High automation—where the vehicle may complete a prescribed trip autonomously under normal environmental conditions, not requiring driver oversight; and Level 5—Full autonomy—where the vehicle may complete a prescribed trip autonomously under any environmental conditions.

In addition to transporting passengers, autonomous vehicles may be used for such duties as pick-up and delivery of freight. Although semi-autonomous vehicles (Levels 2-3) generally require some operator input, oversight, and/or control, fully and highly autonomous vehicles (Levels 4-5) are capable of operating in their environment without human intervention or presence inside the vehicle. Accordingly, where the computing device with the aid of sensors controls all aspects of vehicle operation, the vehicle may completely eschew the presence of an individual capable of interacting with the external environment.

### SUMMARY

A two-way audio-video transmission telepresence system for a motor vehicle having a vehicle exterior, a vehicle interior, and a panel separating the vehicle interior from the vehicle exterior. The system includes a first telecommunication device arranged on the motor vehicle and configured to receive audio and video data from a second telecommunication device situated remotely from the motor vehicle. The system also includes an audio speaker arranged on the vehicle exterior and configured to reproduce the audio data received from the second telecommunication device. The audio speaker may be located proximate the panel. The system additionally includes a visual display device in communication with the first telecommunication device, arranged on the panel and facing the vehicle exterior, and configured to display the video data received from the second telecommunication device toward an environment surrounding the motor vehicle.

The system also includes a microphone arranged on the vehicle exterior proximate the visual display, configured to capture sound proximate the motor vehicle, and communicate the captured sound to the first telecommunication device. The system further includes at least one camera mounted to the motor vehicle and configured to generate an image of at least a portion of the environment surrounding the motor vehicle and communicate the generated image to the first telecommunication device. The first telecommunication device is additionally configured to communicate the captured sound and the generated image to the second telecommunication device to thereby establish real-time communication between the environment surrounding the motor vehicle and the second telecommunication device.

The at least one camera may include a plurality of cameras. Each such camera may be configured to capture a distinct partial view of the environment surrounding the motor vehicle and a corresponding section of the vehicle exterior. The subject plurality of cameras may further stitch together a composite view of the vehicle interior and the environment surrounding the motor vehicle. In such an embodiment, the generated image may include the stitched together composite view.

The second telecommunication device may be configured to display the generated image, including the stitched together composite view.

Alternatively, the at least one camera may include an accessory camera mounted to the motor vehicle and facing the environment surrounding the motor vehicle. The accessory camera may be configured to capture a view of a portion of the environment surrounding the motor vehicle proximate one of a left-hand side and a right-hand side of the vehicle exterior, such as near a typical seating position of a vehicle operator. The generated image displayed by the second telecommunication device may then include the view of the portion of the environment captured by the accessory camera.

The panel may be a vehicle window providing a view of the vehicle interior from the vehicle exterior and vice versa. The captured view of the portion of the environment surrounding the motor vehicle may be proximate the vehicle window.

The above-described accessory camera may be arranged inside the vehicle and capture images through the window.

The second telecommunication device may be configured to communicate the audio and video data from a remote user, such as a custodian or an operator, of the motor vehicle.

The first telecommunication device and the second telecommunication device may be configured to communicate wirelessly via a 5G wireless network, a satellite uplink, or a similar wireless medium.

The motor vehicle may be configured as a self-guided autonomous vehicle.

The remote user may be enabled by the telepresence system to operate various systems of the motor vehicle, such as controlling access into the vehicle by locking/unlocking of vehicle doors, and modifying the vehicle's routing/destination.

A motor vehicle employing the telepresence system for establishing real-time communication between the environment surrounding the motor vehicle and a source of audio and video data, e.g., a user of the vehicle, situated remotely from the motor vehicle is also disclosed.

A method of establishing real-time communication between a remote user of a motor vehicle and an environment surrounding the motor vehicle, such as via the two-way audio-video transmission telepresence system, is further disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic illustration of a two-way audio-video transmission telepresence system for communication between a remotely located user of a motor vehicle and the vehicle's environment using a vehicle mounted first telecommunication device and a remote second telecommunication device, according to the present disclosure.

FIG. 2 is a schematic side view of a motor vehicle having a first telecommunication device, an audio speaker, a visual display device, a microphone, and a camera for the telepresence system shown in FIG. 1, according to the present disclosure.

FIG. 3 is a partial perspective view of the motor vehicle shown in FIGS. 1 and 2, illustrating the visual display device arranged on a vehicle window proximate an expected position of a vehicle driver within the vehicle cabin, according to the present disclosure.

FIG. 4 is a perspective view of the motor vehicle showing an alternative arrangement having a plurality of cameras, according to the present disclosure.

FIG. 5 is a top view of the motor vehicle situated within the vehicle's surrounding environment.

FIG. 6 is a view of a stitched together composite view of the environment surrounding the motor vehicle as seen from a position of a vehicle operator positioned in the vehicle cabin, according to the present disclosure.

FIG. 7 is a plan view of the second telecommunication device configured as a mobile telephone displaying to the remote user of the motor vehicle view the stitched composite view shown in FIG. 6.

FIG. 8 is a flow diagram of a method of establishing real-time communication between a remote user of a motor vehicle and an environment surrounding the motor vehicle via the telepresence system shown in FIGS. 1-7, according to the present disclosure.

### DETAILED DESCRIPTION

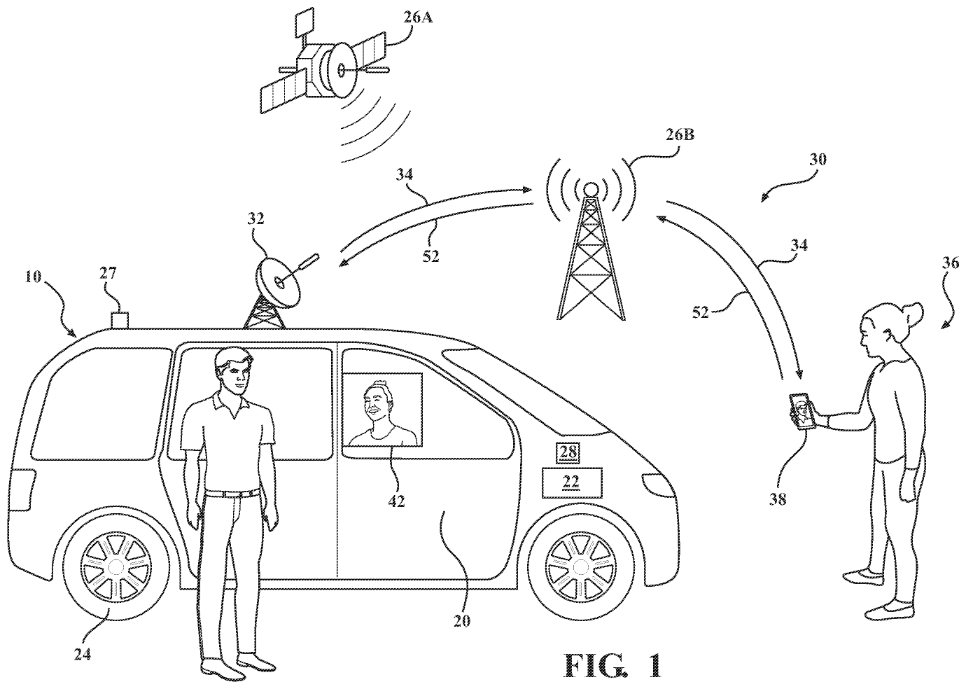

Referring to the drawings, wherein like reference numbers refer to like components throughout the several views, FIG. 1 schematically depicts a motor vehicle 10. The vehicle 10 is generally characterized by a vehicle body 12 having an exterior 14 and an interior or cabin 16, which may be configured to accommodate a vehicle operator and passenger(s). The exterior 14 of the vehicle body 12 includes a front-end section 14-1, a left-hand side section 14-2, and rear-end section 14-3, and a right-hand section 14-4. The vehicle body 12 also includes a panel 18 separating the vehicle interior from the vehicle exterior. The panel 18 may be configured as a window, for example mounted to a vehicle door 20, providing a view of the vehicle interior 16 from the vehicle exterior 14 and vice versa.

As shown in FIG. 1, the motor vehicle 10 includes a powerplant 22 configured to generate an output torque for powering the vehicle. The powerplant 22 may include an internal combustion engine, electric motor(s), and/or a fuel cell configured to propel the vehicle, such via driven wheels 24. The motor vehicle 10 may be configured as a driver-operated, a semi-autonomous, or a self-guided, fully-autonomous vehicle. In general, a semi-autonomous vehicle may control both steering and speed without requiring operator oversight to complete a prescribed trip autonomously under normal environmental conditions, whereas a fully-autonomous vehicle may complete a prescribed trip autonomously under any environmental conditions. A semi-autonomous or a fully autonomous motor vehicle 10 generally receives data from a global positioning satellite (GPS) 26A and data captured by sensors 27, such as cameras, radar, and lidar, to operate vehicle systems and navigate the vehicle with limited or no driver involvement.

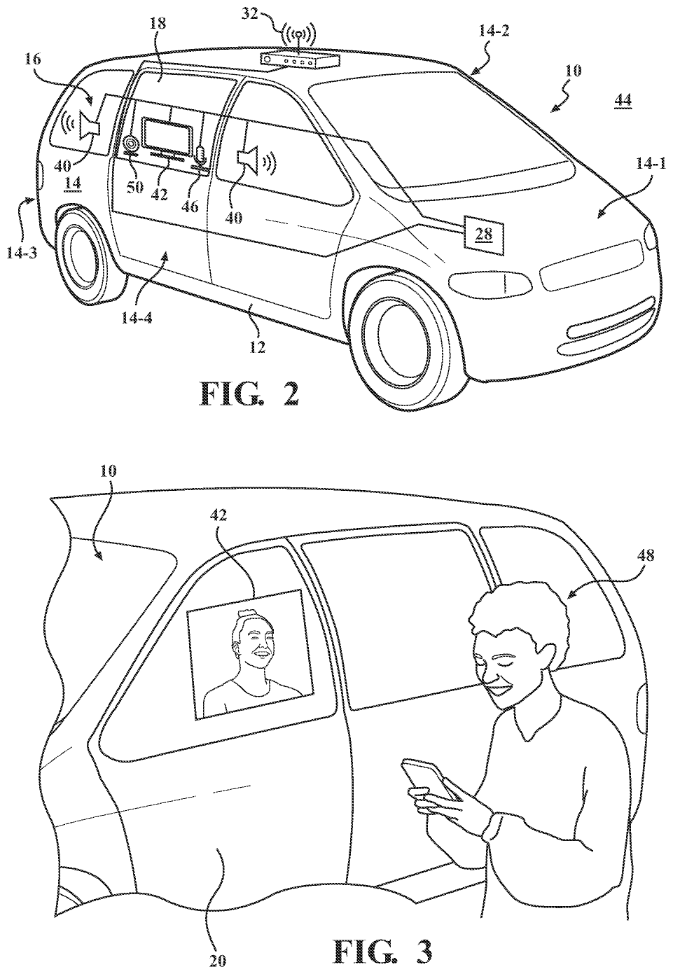

The motor vehicle 10 also includes an electronic controller 28 (shown in FIGS. 1 and 2). The electronic controller 28 may be a central processing unit (CPU) or a body control module (BCM) configured to regulate operation of various vehicle systems. The electronic controller 28 is in operative communication with the sensors 27 and configured or programmed to regulate operation of the semi-autonomous or a fully autonomous motor vehicle 10. Specifically, signals from the sensors 27 may be communicated to the electronic controller 28 via a data network, e.g., a Controller Area Network (CAN bus), arranged in the vehicle 10. The electronic controller 28 includes a memory that is tangible and non-transitory. The memory may be a recordable medium that participates in providing computer-readable data or process instructions. Such a medium may take many forms, including but not limited to non-volatile media and volatile media. Non-volatile media used by the electronic controller 28 may include, for example, optical or magnetic disks and other persistent memory.

Volatile media of each of the controller's memory may include, for example, dynamic random-access memory (DRAM), which may constitute a main memory. Such instructions may be transmitted by one or more transmission medium, including coaxial cables, copper wire and fiber optics, including the wires that comprise a system bus coupled to the sensors 27. Memory of the electronic controller 28 may also include a flexible disk, hard disk, magnetic tape, other magnetic medium, a CD-ROM, DVD, other optical medium, etc. The electronic controller 28 may be equipped with a high-speed primary clock, requisite Analog-to-Digital (A/D) and/or Digital-to-Analog (D/A) circuitry, input/output circuitry and devices (I/O), as well as appropriate signal conditioning and/or buffer circuitry. Algorithms required by the electronic controller 28 or accessible thereby may be stored in the memory and automatically executed to provide the required functionality.

The motor vehicle 10 may be part of a two-way, audio-video transmission telepresence system 30 (shown in FIG. 1). The telepresence system 30 may be in operative communication with the electronic controller 28 and configured to communicate with and/or utilize various vehicle systems, including the sensors 27. The telepresence system 30 includes a first telecommunication hardware device 32 arranged on or mounted to the motor vehicle 10 (shown in FIG. 2). The first telecommunication device 32 configured to receive, in real-time, a data communication 34 (shown in FIG. 1) from a source 36 situated remotely from the motor vehicle 10. The source 36 of the data communication 34 may be a user, such as an operator, custodian, or owner of the motor vehicle 10.

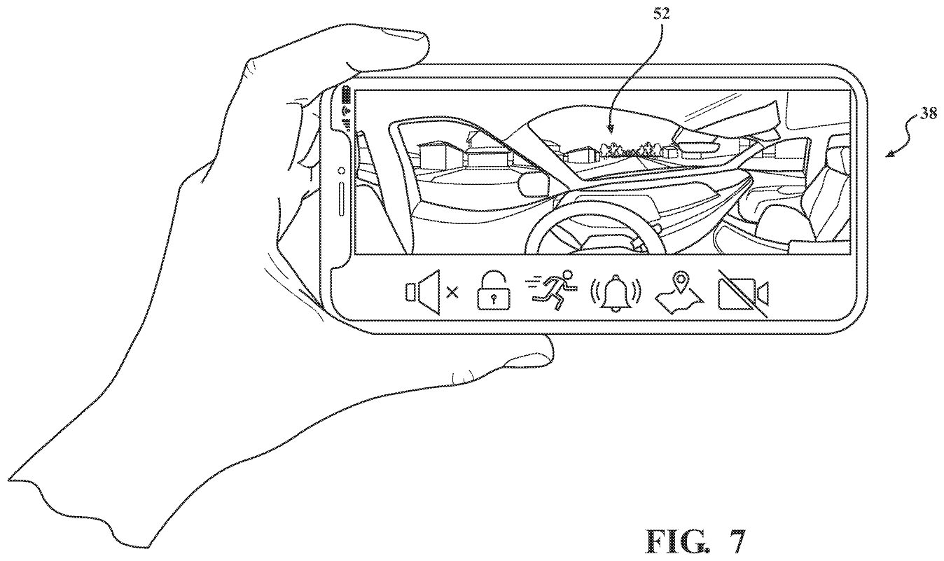

The data communication 34 is intended to be implemented by the source 36 via a second telecommunication device 38 (shown in FIG. 1) located remotely from the vehicle, for example, in possession of the data source, and include both audio and video. The second telecommunication device 38 may be a mobile telephone (shown in FIG. 7), a tablet, a personal computer, etc. The first telecommunication device 32 and the second telecommunication device 38 may be configured to communicate wirelessly via the satellite 26A uplink, via a 5G wireless network 26B, or via a similar wireless medium. As shown in FIG. 2, the telepresence system 30 also includes an audio speaker 40 arranged on or mounted to the vehicle exterior 14 and configured to reproduce, in real-time, the audio data received from the second telecommunication device 38. The audio speaker 40 may be arranged proximate the panel 18.

With continued reference to FIG. 2, the telepresence system 30 additionally includes a visual display device 42 in communication with the first telecommunication device 32. The visual display device 42 is arranged on or mounted to the panel 18 and facing the vehicle exterior 14. The visual display device 42 is configured to display, in real-time, the video data received from the second telecommunication device 38 toward an environment 44 surrounding the motor vehicle 10. In other words, visual display device 42 is directed away from the vehicle exterior 14, so the video data received from the second telecommunication device 38 may be seen by an individual situated in the environment 44. The visual display device 42 may be a video monitor incorporated into the window 18.

The telepresence system 30 additionally includes a microphone 46 (shown in FIG. 2) arranged on or mounted to the vehicle exterior 14 proximate the visual display 42. The microphone 46 is configured to capture sound proximate the motor vehicle 10, i.e., within the environment 44, and communicate the captured sound to the first telecommunication device 32. The telepresence system 30 further includes one or more cameras 50 mounted to the motor vehicle 10. Each camera 50 is configured to generate an image 52 of at least a portion of the environment 44, i.e., proximate the vehicle exterior 14, and communicate the generated image to the first telecommunication device 32.

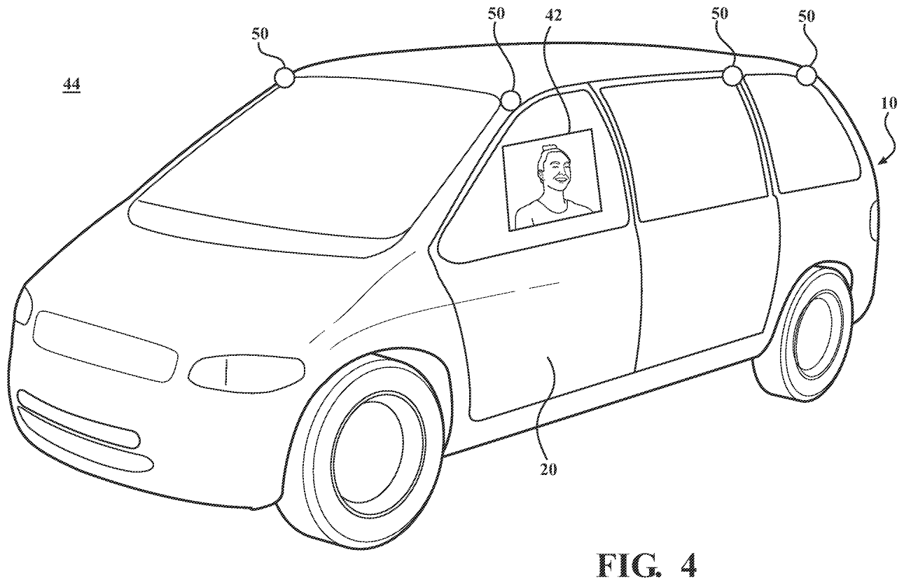

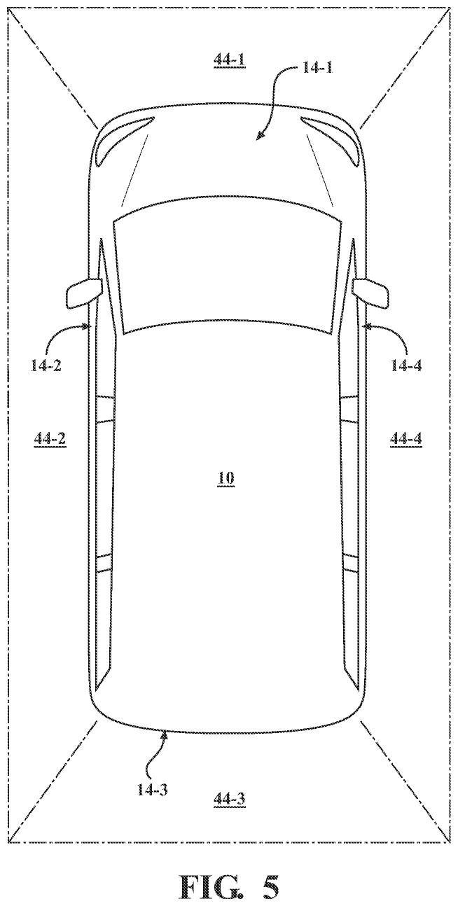

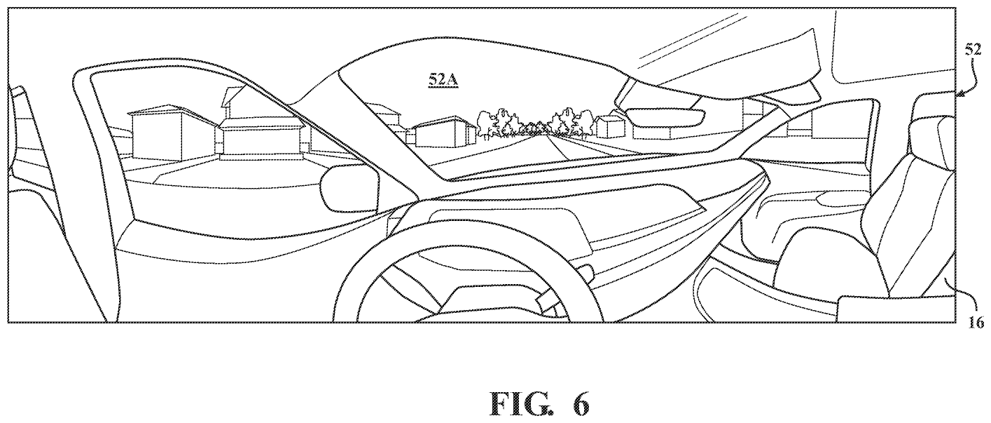

In the embodiment of the telepresence system 30 having a plurality of cameras 50 (shown in FIG. 4), each camera may be configured to capture a distinct partial view or portion 44-1, 44-2, 44-3, 44-4 of the environment 44 (shown in FIG. 5). Such a plurality of cameras 50, with the aid of an algorithm programmed into the electronic controller 28, may then be used to stitch together a composite view 52A (shown in FIG. 6) of the environment 44 and an overlaid static image of the vehicle interior 16. A dedicated algorithm programmed into the electronic controller 28 may be employed to generate the stitched together composite view 52A. The generated image 52 may then include the stitched together composite view 52A.

Specifically, the stitched-together exterior image 52A and the static image of the interior 16 may be combined on the vehicle side, as a function of the first telecommunication device 32 and then communicated to the second telecommunication device 38 for displaying thereon. Alternatively, the stitched-together exterior image 52A may be communicated (sans overlaid image of the interior 16) to the second telecommunication device 38, with the second telecommunication device overlaying the static interior 16 image programmed therein to generate the image 52. Accordingly, in such an embodiment, the second telecommunication device 38 may be configured to superimpose the video data received from the vehicle mounted camera(s) 50 over an existing or saved image of the vehicle interior 16. Each of the above options would, therefore, result in the same image 52 being viewed on the remote device 38, as shown in FIG. 7, to create an illusion of the perspective a remote user, i.e., source 36, would have if he or she were situated in the vehicle 10.

In a separate embodiment, a single accessory camera 50, as shown in FIG. 2, may be used to generate the requisite image 52. The accessory camera 50 may be mounted to the motor vehicle 10 and facing the environment 44. For example, the accessory camera 50 may be mounted directly to the exterior 14 or arranged within the interior 16 to capture images through the window 18. The accessory camera 50 may be configured to capture a view of a portion of the environment 44 surrounding the motor vehicle proximate one of the left-hand side 14-2 and the right-hand side 14-4 of the vehicle exterior 14, e.g., near a vehicle operator's expected seating position. In such a case, the captured view of the portion 44-2 or 44-4 of the environment 44 would be proximate the vehicle window 18. The captured view of the environment 44 would enable the remote user 36 of the motor vehicle 10 to observe the subject portion of the environment and interact with an individual 48 as if the remote user was actually present in, i.e., situated within, the vehicle.

The first telecommunication device 32 is additionally configured to communicate the captured sound and the generated image 52 to the second telecommunication device 38. The second telecommunication device 38 may then display the generated image 52, such as including the stitched together composite view 52A or include the view of the portion of the environment 44 captured by the accessory camera 50. The remote user of the motor vehicle 10 may therefore receive to view the stitched composite view 52A on the second telecommunication device 38, as shown in FIG. 7. Accordingly, the captured sound and the generated image proximate the vehicle 10 establish real-time communication between the environment 44 and the second telecommunication device 38. For example, if the motor vehicle 10 is tasked with autonomously making delivery of a shipment, it may need to stop at a merchandise drop-off or pick-up location attended by an authorized individual 48 (shown in FIG. 3), or an entry gate operated by a security guard. The telepresence system 30 would thus enable communication of the remote motor vehicle 10 user with the security guard and permit real-time resolution of authorization or recordation issues, address and alleviate possible areas of confusion, and adjust or alter vehicle waiting period and routing.

The telepresence system 30 may employ the above-described real-time communication in combination with algorithms programmed into the electronic controller 28 and assistance from the vehicle sensors 27 to enable further interaction of the motor vehicle 10 with its surroundings. For example, the telepresence system 30 may enable the motor vehicle 10 user to remotely operate various vehicle systems, for example, by locking/unlocking of the door 20 to control access into the vehicle, and control vehicle operation, such as by pausing vehicle forward progress or revising the vehicle's routing/destination, etc.

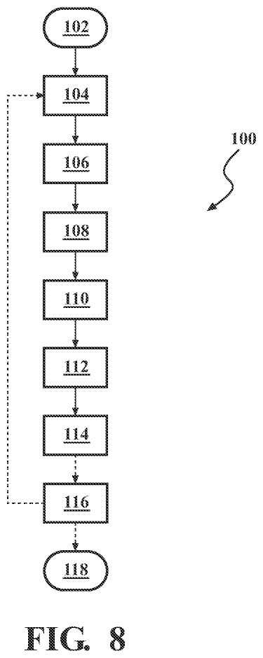

FIG. 8 depicts a method 100 of establishing real-time communication between a remote user of a motor vehicle 10 and the environment 44 surrounding the motor vehicle, such as via the two-way audio-video transmission telepresence system 30, as described above with respect to FIGS. 1-7. The method 100 may be implemented with the aid of the electronic controller 28 and the algorithms programmed therein. The method 100 initiates in frame 102 with the motor vehicle being operated with respect to the environment 44 with the vehicle's user, such as a custodian or operator, located distally from the vehicle. In frame 102, the motor vehicle 10 may approach a place of business where, for example, it may be required to stop for an interaction with an agent of the establishment's security service.

Following frame 102, the method proceeds to frame 104, where the method includes receiving, via the first telecommunication device 32 audio and video data from a remotely located user of the motor vehicle 10 via the second telecommunication device 38. After frame 104, the method advances to frame 106. In frame 106 the method includes reproducing via the audio speaker 40 the audio data received from the second telecommunication device 38. Following frame 106, the method proceeds to frame 108. In frame 108 the method includes displaying via the visual display device 42 the video data received from the second telecommunication device 38 toward environment 44. Following frame 108, the method may proceed to frame 110. In frame 110 the method includes capturing, via the microphone 46, sound proximate the motor vehicle 10 and communicating the captured sound to the first telecommunication device 32.

After frame 110, the method advances to frame 112 for generating via one or more cameras 50 the image 52 of relevant portion(s) of the environment 44 and communicating the generated image to the first telecommunication device 32. As described with respect to FIGS. 1-7, in an embodiment where the telepresence system 30 includes a plurality of cameras 50, in frame 112 the method may further include capturing a distinct partial view of the environment 44 proximate a corresponding section, the front-end section 14-1, the left-hand side section 14-2, the rear-end section 14-3, and the right-hand side section 14-4 of the vehicle exterior 14. Additionally, in frame 112 the method may include stitching together a view of the environment 44 via each of the plurality of cameras 50. Furthermore, in frame 112 the method may include superimposing a static image of the vehicle interior 16 upon the stitched together view of the environment 44 to generate the stitched together composite view 52A for the image 52 sent to and displayed on the remote device 38.

Alternatively, in frame 112 the camera 50 may be an accessory camera mounted to the motor vehicle, such as to the exterior 14, and facing the environment 44 to capture images through the window 18. In such an embodiment, in frame 112 the method may include capturing, via the subject accessory camera 50, a view of a portion of the environment 44 next to the driver's position, e.g., proximate either the left-hand side 14-2 and the right-hand side 14-4 of the vehicle exterior 14. Following frame 112, the method proceeds to frame 114. In frame 114 the method includes communicating via the first telecommunication device 32 the captured sound and the generated image 52 to the second telecommunication device 38 to thereby establish real-time communication between the environment 44 and the second telecommunication device. After frame 114, the method may advance to frame 116. In frame 116 the method may include enabling the vehicle user to remotely operate vehicle systems, for example, to grant or restrict access into the vehicle by locking/unlocking the door 20, or to revise the vehicle's routing or destination.

After frame 116, the method may loop back to frame 104 for continued communication between the remote vehicle user and various individuals situated in the vehicle environment 44. The method 100 may conclude in frame 118 once the needed interaction of the motor vehicle's remote user with the environment 44 has been completed, allowing the motor vehicle to proceed along its route toward its destination. Accordingly, the method 100 permits a self-guided autonomous motor vehicle 10 to accomplish various tasks which may require real-time decision making as a consequence of communication between individuals.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A telepresence system for a motor vehicle having a vehicle exterior, a vehicle interior, and a panel separating the vehicle interior from the vehicle exterior, the system comprising:
a first telecommunication device arranged on the motor vehicle and configured to receive audio and video data from a second telecommunication device situated remotely from the motor vehicle;
an audio speaker arranged on the vehicle exterior and configured to reproduce the audio data received from the second telecommunication device;
a visual display device in communication with the first telecommunication device, arranged on the panel, facing the vehicle exterior, and configured to display the video data received from the second telecommunication device toward an environment surrounding the motor vehicle;
a microphone arranged on the vehicle exterior proximate the visual display and configured to capture sound proximate the motor vehicle and communicate the captured sound to the first telecommunication device; and
at least one camera mounted to the motor vehicle and configured to generate an image of at least a portion of the environment surrounding the motor vehicle and communicate the generated image to the first telecommunication device;
wherein the first telecommunication device is additionally configured to communicate the captured sound and the generated image to the second telecommunication device to thereby establish real-time communication between the environment surrounding the motor vehicle and the second telecommunication device.

2. The telepresence system according to claim 1, wherein the at least one camera includes a plurality of cameras, each configured to capture a distinct partial view of the environment surrounding the motor vehicle and a corresponding section of the vehicle exterior and stitch together a composite view of the vehicle interior and the environment surrounding the motor vehicle, and wherein the generated image includes the stitched together composite view.

3. The telepresence system according to claim 1, wherein the at least one camera includes an accessory camera mounted to the motor vehicle and facing the environment surrounding the motor vehicle, and wherein the accessory camera is configured to capture a view of a portion of the environment surrounding the motor vehicle proximate one of a left-hand side and a right-hand side of the vehicle exterior.

4. The telepresence system according to claim 3, wherein the panel is a vehicle window providing a view of the vehicle interior from the vehicle exterior and vice versa, and wherein the captured view of the portion of the environment surrounding the motor vehicle is proximate the vehicle window.

5. The telepresence system according to claim 1, wherein the second telecommunication device is configured to display the generated image.

6. The telepresence system according to claim 1, wherein the second telecommunication device is configured to communicate the audio and video data from a remote user of the motor vehicle.

7. The telepresence system according to claim 1, wherein the first telecommunication device and the second telecommunication device are configured to communicate wirelessly via a 5G wireless network or a satellite uplink.

8. A motor vehicle comprising:
a vehicle exterior;
a vehicle interior;
a panel separating the vehicle interior from the vehicle exterior;
a first telecommunication device configured to receive audio and video data from a second telecommunication device situated remotely from the motor vehicle;
an audio speaker arranged on the vehicle exterior and configured to reproduce the audio data received from the second telecommunication device;
a visual display device in communication with the first telecommunication device, arranged on the panel, facing the vehicle exterior, and configured to display the video data received from the second telecommunication device toward an environment surrounding the motor vehicle;
a microphone arranged on the vehicle exterior proximate the visual display and configured to capture sound proximate the motor vehicle and communicate the captured sound to the first telecommunication device; and
at least one camera configured to generate an image of at least a portion of the environment surrounding the motor vehicle and communicate the generated image to the first telecommunication device;
wherein the first telecommunication device is additionally configured to communicate the captured sound and the generated image to the second telecommunication device to thereby establish real-time communication between the environment surrounding the motor vehicle and the second telecommunication device.

9. The motor vehicle according to claim 8, wherein the at least one camera includes a plurality of cameras, each configured to capture a distinct partial view of the environment surrounding the motor vehicle and a corresponding section of the vehicle exterior and stitch together a composite view of the vehicle interior and the environment surrounding the motor vehicle, and wherein the generated image includes the stitched together composite view.

10. The motor vehicle according to claim 8, wherein the at least one camera includes an accessory camera mounted to the motor vehicle and facing the environment surrounding the motor vehicle, and wherein the accessory camera is configured to capture a view of a portion of the environment surrounding the motor vehicle proximate one of a left-hand side and a right-hand side of the vehicle exterior.

11. The motor vehicle according to claim 10, wherein the panel is a vehicle window providing a view of the vehicle interior from the vehicle exterior and vice versa, and wherein the captured view of the portion of the environment surrounding the motor vehicle is proximate the vehicle window.

12. The motor vehicle according to claim 8, wherein the second telecommunication device is configured to display the generated image.

13. The motor vehicle according to claim 8, wherein the second telecommunication device is configured to communicate the audio and video data from a remote user of the motor vehicle.

14. The motor vehicle according to claim 8, wherein the first telecommunication device and the second telecommunication device are configured to communicate wirelessly via a global positioning satellite (GPS) or via a 5G wireless network.

15. A method of establishing real-time communication between a remote user of a motor vehicle and an environment surrounding the motor vehicle, the method comprising:
receiving, via a first telecommunication device arranged on the motor vehicle, audio and video data from a second telecommunication device situated remotely from the motor vehicle, wherein the vehicle includes a vehicle exterior, a vehicle interior, and a panel separating the vehicle interior from the vehicle exterior;
reproducing, via an audio speaker arranged on the vehicle exterior, the audio data received from the second telecommunication device;
displaying, via a visual display device in communication with the first telecommunication device, arranged on the panel, and facing the vehicle exterior, the video data received from the second telecommunication device toward the environment surrounding the motor vehicle;
capturing, via a microphone arranged on the vehicle exterior proximate the visual display, sound proximate the motor vehicle and communicating the captured sound to the first telecommunication device;
generating, via at least one camera mounted to the motor vehicle, an image of at least a portion of the environment surrounding the motor vehicle and communicating the generated image to the first telecommunication device; and
communicating, via the first telecommunication device, the captured sound and the generated image to the second telecommunication device, to thereby establish real-time communication between the environment surrounding the motor vehicle and the second telecommunication device.

16. The method according to claim 15, wherein the at least one camera includes a plurality of cameras, the method further comprising capturing a distinct partial view of the environment surrounding the motor vehicle and a corresponding section of the vehicle exterior and stitching together a composite view of the vehicle interior and the environment surrounding the motor vehicle via each of the plurality of cameras to generate the image.

17. The method according to claim 15, wherein the at least one camera includes an accessory camera mounted to the motor vehicle and facing the environment surrounding the motor vehicle, the method further comprising capturing, via the accessory camera, a view of a portion of the environment surrounding the motor vehicle proximate one of a left-hand side and a right-hand side of the vehicle exterior.

18. The method according to claim 15, further comprising displaying the generated image via the second telecommunication device.

19. The method according to claim 15, further comprising communicating, via the second telecommunication device, the audio and video data from a remote user of the motor vehicle.

20. The method according to claim 15, wherein the first telecommunication device and the second telecommunication device communicate wirelessly via a 5G wireless network or a satellite uplink.
